(19) United States
(12) Patent Application Publication
(10) Pub. No.: US 2007/0076233 A1
(43) Pub. Date: Apr. 5, 2007

(54) Nano-engineered transparent and fluorescent colorants

(76) Inventors: David L. Lee, Tacoma, WA (US); Edwin Hirahara, Federal Way, WA (US); David Wallack, Hillsboro, OR (US)

Correspondence Address: WEYERHAEUSER COMPANY;INTELLECTUAL PROPERTY DEPT., CH 1J27, P.O. BOX 9777, FEDERAL WAY, WA, 98063, US

(21) Appl. No.: 11/238,460

(22) Filed: Sep. 29, 2005

(51) Int. Cl. H04N 1/60

(52) U.S. Cl. 358/1.9

(57) ABSTRACT

A method is provided for manufacturing a new class of transparent and fluorescent colorants, such as printing inks suitable for use in process printing or non-process printing. The method includes generally two steps. In one embodiment, first, one or more types of fluorescent nanodots, or nanocrystal fluorophores, are selected for creating an ink of a predefined color. Second, the selected nanodots are combined (e.g., by doping process) with a transparent base ink to create a transparent and fluorescent ink of the predefined color. Due to the wide color variety of nanodots, such transparent and fluorescent printing inks may be produced as primaries in more colors than conventional transparent or fluorescent inks, and further can be selectively combined (i.e., overprinted) to create an unlimited number of secondary and tertiary colors. Still, further, the fluorescent nature of these inks render the resulting color images extremely bright and vivid, to add a further aesthetic appeal to the graphical designs when printed using these inks.

### FIELD OF THE INVENTION

The present invention generally relates to colorants such as printing inks, and, more specifically, to a method of creating a new class of transparent and fluorescent colorants such as printing inks, which may be particularly useful in printing aesthetically appealing graphical designs in the packaging industry.

### BACKGROUND OF THE INVENTION

Virtually all consumer products are sold in packages, such as cardboard cartons, boxes, and other types of containers. A package has two very distinguishing features: a structural design and a graphical design. The structural design of a package is defined by the package's structural features, such as the dimensions, geometric shape, and material of the package. The graphical design of a package is defined by the colors, artwork, and other images applied thereto. The graphical design preferably identifies the packaged product in a manner which is aesthetically appealing to potential consumers.

A package is typically formed from a sheet of corrugated board, carton board, or other work material upon which a graphical design is applied. The graphical design may be applied by many known processes. For example, a vinyl sheet having a design may be laminated to the package, or the package itself may be printed.

Printing inks to be used in applying a graphical design to a package can generally be categorized as either transparent or opaque. This is true regardless of the method of printing, whether it is analog (e.g., lithography, flexography, screen, gravure) or digital (e.g., ink jet, xerography). Transparent printing inks behave like water colors in that the overprinting of two primary colors gives rise to a third color. For example, a transparent red ink printed on top of a transparent yellow ink will produce an orange. Opaque printing inks, on the other hand, behave more like paints; they are designed to hide whatever lies underneath. If two opaque inks are overprinted, generally the top (i.e., the last applied) ink will provide the color that is visible to a viewer. For example, an opaque yellow ink printed over an opaque red ink will continue to appear yellow because its opacity prevents the red underneath from showing through and/or muddying the overprinted yellow color. Conventional “process printing,” such as CMY (Cyan, Magenta, Yellow), CMYK (CMY and blacK), and Hexachrome™ (CMYK plus orange and green) process printing, all rely on overprinting transparent inks to build their color images. Similarly, non-process printing architectures based on alternative or additional color separation and reproduction methods, such as ChromaPak® color printing architecture available from Weyerhaeuser Company of Federal Way, Wash., also use two or more colors of transparent printing inks. ChromaPak® color printing architecture, for example, uses two or more colors of transparent printing inks, none of which must be a subtractive primary (CMY) to build secondary and tertiary colors. Some details of ChromaPak® color printing architecture are disclosed in co-assigned U.S. Pat. No. 6,854,387 and U.S. patent application Ser. No. 09/887,867, filed Jun. 22, 2001 and Ser. No. 10,815,154, filed Mar. 31, 2004, which are explicitly incorporated herein by reference.

As should be appreciated based on the foregoing description, transparent inks have certain advantages over opaque inks especially when the need exists for generating secondary and tertiary colors based on a limited number of primaries.

Besides transparency, another desirable characteristic for printing inks to have is fluorescence. Fluorescent inks, when printed on a substrate such as a sheet of cardboard, produce very bright and saturated (or vivid) colors, which may well be very appealing to human eyes. Conventional fluorescent inks, such as Day Glo™ inks available from RPM International Inc. of Medina, Ohio, are made by mixing transparent base inks with various types of fluorescent pigments. While such pigments provide the desired fluorescence, in many cases they also produce an undesirable characteristic—opacity. This is because pigments tend to scatter light. Specifically, high pigment loadings are necessary to achieve a desired level of fluorescence, which in turn brings about a high degree of light scattering by the pigments. As such, conventional fluorescent printing inks are essentially opaque and therefore not suitable for use in overprinting (for building secondary and tertiary colors) in process printing or non-process printing applications.

Accordingly, a need exists for a class of transparent and fluorescent printing inks, which can be used in process printing or non-process printing applications.

### SUMMARY OF THE INVENTION

The present invention is directed to manufacturing a new class of transparent and fluorescent colorants such as printing inks, suitable for use in process printing or non-process printing. Such transparent and fluorescent printing inks may be produced as primaries in more colors than conventional transparent or fluorescent inks. Further, these primaries can be selectively combined (i.e., overprinted) to create an unlimited number of secondary and tertiary colors. Still further, the fluorescent nature of these inks render the resulting color images extremely bright and vivid, to add a further aesthetic appeal to the graphical designs when printed using these inks.

In accordance with one aspect of the present invention, a method is provided for creating a transparent and fluorescent colorant such as a printing ink. The method includes generally two steps. First, one or more types of fluorescent nanodots (or nanocrystal fluorophores) are selected for creating a colorant of a predefined color. Second, the selected nanodots are combined with a transparent base colorant to create a transparent and fluorescent colorant of the predefined color. In various exemplary embodiments of the present invention, the transparent base colorant is a transparent pigment-based or dye-based ink, and the step of combining the selected nanodots with a transparent base colorant is carried out by doping the base colorant (i.e., the base ink in this case) with the selected nanodots. When a transparent ink is used as the base colorant, the method may optionally include the third step of confirming that the created transparent and fluorescent ink actually produces the predefined color when printed on a substrate, such as a sheet of containerboard, fiberboard, linerboard, cardboard, paperboard, corrugated board, and styrene.

In accordance with another aspect of the present invention, a method is provided for creating a CMY set of transparent and fluorescent printing inks. The method includes generally two steps. First, one or more types of fluorescent nanodots are selected for creating printing inks in cyan, magenta, and yellow, respectively. Second, the selected nanodots are combined with transparent base inks to create transparent and fluorescent inks in cyan, magenta, and yellow, respectively. As before, the step of combining the selected nanodots with transparent base inks may be carried out by doping the base inks with the selected nanodots to create transparent and fluorescent inks in cyan, magenta, and yellow, respectively. Also as before, the method may optionally include the third step of confirming that the created transparent and fluorescent inks actually produce cyan, magenta, and yellow, respectively, when printed on a substrate.

In accordance with another aspect of the present invention, a method is provided for creating a set of “spot-color” transparent and fluorescent printing inks suitable for reproduction of color graphics using non-process printing architectures, such as ChromaPak® color printing architecture. ChromaPak® color printing architecture, for example, uses two or more colors of transparent printing inks, none of which must be a subtractive primary (CMY) to build secondary and tertiary colors. It is an alternative or additional (with respect to CMY) color separation and reproduction method.

Briefly, a “spot color” is any arbitrary color and is a graphic-arts term used to refer to a stand-alone color that is often added to a graphic reproduction to improve its color and image quality. The use of spot colors is often preferred since they are easier to print (i.e., each color can be printed with a single ink) than attempting to emulate each of the spot colors by building it with complex overprints of process colors (three inks). Also, oftentimes, a spot color falls outside the color gamut of process inks, hence the built color based on the process inks will fail to match the desired spot color. Thus, spot colors are pre-built and used, rather than built based on process inks, to generally supplement or provide alternatives to process inks.

The method in accordance with the present invention includes generally two steps. First, one or more types of fluorescent nanodots are selected for creating printing inks in a predefined set of spot colors such as red, green, blue, pink, and purple. Second, the selected nanodots are combined with transparent base inks to create transparent and fluorescent inks in the predefined set of spot colors, respectively, such as red, green, blue, pink, and purple. As before, the step of combining the selected nanodots with transparent base inks may be carried out by doping the base inks with the selected nanodots to create the transparent and fluorescent inks in the predefined set of spot colors, respectively. Also as before, the method may optionally include the third step of confirming that the created transparent and fluorescent inks actually produce the predefined set of spot colors, respectively, when printed on a substrate.

### DETAILED DESCRIPTION OF THE PREFERRED EMBODIMENT

The invention is directed to manufacture of a new class of transparent and fluorescent colorants. As used herein, the term “colorant” means any materials that may be used to add a color to or in another material, such as printing inks, paints, dyes, pigments, etc. In accordance with various exemplary embodiments of the present invention, such colorants (e.g., printing inks) may be produced by doping conventional transparent base colorants (e.g., transparent base inks) with nanocrystal fluorophores of appropriate color or colors. Such nanocrystal fluorophores are called “nanodots” or quantum dots and are commercially available.

Some properties of nanodots are described herein. The physical properties of a bulk material, such as gold, change as it is cut from its original macro-scale size into successively smaller and smaller pieces to, for example, a collection of nano-sized particles (e.g., 10⁻⁹ m). At the nano-scale, the color of gold is no longer gold (or yellow), and could be orange, purple, red, or green, depending on its size and also shape (sphere, prism, etc.) This type of nano-fabrication is called top-down fabrication, since it is started with a large macro-scale structure which is successively cut into a collection of smaller pieces. Conversely, a method of starting with individual atoms and building them up to a nanostructure is called bottom-up nanofabrication. Such small nanostructures of material are referred to as nanodots, because they are roughly dot-shaped and have diameters on the order of 10 s of nanometers (roughly 2-30 nm in diameter). At nano-scale dimensions, the physical properties of such materials behave according to the law of quantum physics rather than Newtonian physics.

Nanodots can be formulated to emit at wavelengths ranging from 350 nm to 2500 nm. Nanodots are typically single nanocrystals with a coating that ensures stability and preserves the optical properties of the nanocrystals in water. In short, they are biologically inert and conjugation ready. They are more stable than organic fluors and their excitation bands are considerably broader, ranging from the UV to visible to the near infrared, depending on species, while their emission bands are relatively narrow (<40 nm). Another advantageous characteristic of nanodots is that they tend to fluoresce longer than conventional fluorescent dyes. Depending on species, many will continue to fluoresce hours after initial excitation, some achieving as high as 90% of their original intensity one hour after initial excitation.

Nanodots in various sizes, shapes, and (emission) colors have been engineered and are commercially available from companies such as Evident Technologies of Troy, N.Y., and Quantum Dot Corporation of Hayward, Calif. Commercially available luminescent fluorophores, or nanodots, are used primarily in the biomedical field, and are marketed to assay developers, biotech researchers, reagent developers, etc., to tag and track particular cells in the body (cell imaging) or other structures (e.g., in pathogen detection). To date, however, these nanodots have not been applied or exploited in the manufacture of colorants, such as printing inks.

The inventors of the present invention have discovered that these nanodots can be exploited to create a new class of transparent and fluorescent colorants, such as printing inks, paints, etc., by, for example, doping conventional transparent colorants (e.g., printing inks) with one or more types of nanodots of appropriate color or colors. Advantageously, these nanodots are available in more colors than conventional organic dyes. This allows them to be mixed with, for example, a large gamut of transparent base inks (in various colors), to thereby yield a very broad class of transparent and highly fluorescent printing inks. Due to the optical properties of nanodots, stemming in part from their extremely small size (typically smaller than the wavelength of excitation light to thereby not cause any light scattering), a transparent base ink, either pigment-based or dye-based, will retain its transparency even after it is combined with nanodots.

In accordance with one embodiment of the present invention, a method is provided to create a transparent and fluorescent colorant, such as a printing ink. Specifically, the method includes the step of selecting one or more types of nanodots of suitable or predefined color or colors, and the further step of combining the selected nanodots with a transparent base colorant (e.g., a transparent base ink) to create a transparent and fluorescent colorant of the predefined color. As described above, various types and colors of nanodots are commercially available, and so are various types and colors of transparent base colorants. Thus, one skilled in the art could readily select suitable type and amount of nanodots to be combined with a suitably selected base colorant (e.g., a base ink), to thereby create a transparent and fluorescent colorant of any desired color in a wide range of colors. In some applications, two or more types of nanodots in the same or varying mixing ratio may be selected and used to create a transparent and fluorescent colorant of a particular color.

When a transparent and fluorescent ink of a desired color is created according to the present invention, optionally, the created transparent and fluorescent ink may then be printed on a substrate so that a viewer can visually confirm that the printed color actually matches the predefined color as originally intended. The substrate to print the ink on may be selected from, for example, a sheet of containerboard, fiberboard, linerboard, cardboard, paperboard, corrugated board, and styrene. Transparent and fluorescent colorants, other than transparent and fluorescent printing inks, formed in accordance with the present invention may then be added to materials, such as glass, for making filters, for coloring plastics, etc., and their resulting colors may be visually confirmed in a similar manner.

Transparent base inks suitable for use in the present invention include but are not limited to those disclosed in commonly assigned U.S. Pat. No. 6,854,387 issued to Lee et al. on Feb. 15, 2005, the disclosure of which is incorporated herein by reference. Transparent base inks may be either pigment-based or dye-based. The composition of a transparent base ink suitable for use in the present invention includes any liquid composition which may be applied onto a substrate in a predetermined pattern, for example by using flexography.

Components of the composition of a transparent base ink may include but are not limited to: a vehicle such as a solvent or water; a coloring element such as a pigment, pigment grinding, and letdown vehicles in colloidal, solution, or emulsion form; and other components which may include but are not limited to wax, pH control agents, viscosity modifiers, antifoamers, dispersants, antimicrobial agents, ink transfer agents, and drying speed modification agents. The vehicle may contain a combination of acrylic, maleic, or other resins.

A transparent base ink may be defined as any composition or components thereof applied to a substrate and which remains thereon in a visible pattern even though components of the ink may evaporate. Such inks may be printed separately or overprinted on top of each other.

Addition of nanodots into a transparent base ink may be akin to that of other additives, in that nanodots can be added directly into the inks. Nanodots can be diluted with water or solvent prior to addition to the ink for ease of incorporation. In one embodiment, the addition should be carried out slowly into the vortex of the ink with sufficient agitation.

The amount of fluorescence exhibited by the fluorescent colorant (e.g., a fluorescent ink) formed in accordance with the present invention is dependent on the amount of nanodots added to the transparent non-fluorescing base colorant. As should be well understood by one skilled in the art, a relatively small amount of nanodots, as compared to conventional fluorescent pigments, may be sufficient to produce a desirable color that fluoresces, due to the physical and optical properties specific to various nanodots.

In accordance with a further embodiment of the present invention, transparent and fluorescent printing inks may be created in cyan, magenta, and yellow, to be used as primaries in process printing such as CMY and CMYK (black in CMYK may be non-fluorescent). These transparent and fluorescent printing inks may thus be used to build a large gamut of secondary and tertiary colors in various process printing applications. In accordance with a still further embodiment of the present invention, additional transparent and fluorescent printing inks, i.e., “spot” colors, in orange and green may be created for use in Hexachrome™ printing process, which uses CMYK plus orange and green. Without loss of generality, any spot color ink could be produced using a method of the present invention.

Specifically, in accordance with another embodiment of the present invention, a method is provided to create a class of transparent and fluorescent printing inks, such as in cyan, magenta, and yellow as in CMY format. The method includes the step of selecting one or more types of nanodots corresponding to each of cyan, magenta, and yellow, respectively. The method includes the further step of combining the selected one or more types of nanodots for cyan, magenta, and yellow, with transparent base inks, respectively, to thereby create transparent and fluorescent inks in cyan, magenta, and yellow, respectively. As before, the created inks may then be printed on a substrate so that a viewer can visually confirm whether the printed colors actually correspond to the desired cyan, magenta, and yellow colors, respectively.

In accordance with yet another embodiment of the present invention, a method is provided for creating a set of “spot-color” transparent and fluorescent printing inks suitable for reproduction of color graphics using non-process printing architectures, such as ChromaPak® color printing architecture. ChromaPak® color printing architecture, for example, uses two or more colors of transparent printing inks, none of which must be a subtractive primary (CMY) to build secondary and tertiary colors.

The method includes generally two steps. First, one or more types of fluorescent nanodots are selected for creating printing inks in a predefined set of spot colors, such as red, green, blue, pink, and purple. Second, the selected nanodots are combined with transparent base inks to create transparent and fluorescent inks in the predefined set of spot colors, respectively, such as in red, green, blue, pink, and purple. As before, the step of combining the selected nanodots with transparent base inks may be carried out by doping the base inks with the selected nanodots to create the transparent and fluorescent inks in the predefined set of spot colors, respectively. Also as before, the method may optionally include the third step of confirming that the created transparent and fluorescent inks actually produce the predefined set of spot colors, respectively, when printed on a substrate.

As should be apparent to one skilled in the art, the transparent and fluorescent printing inks formed in accordance with the present invention may be readily used in conventional process printing systems (e.g., CMY, CMYK, etc.) or non-process printing systems (e.g., ChromaPak®, etc.), with little or no change required in production or graphic reproduction workflows.

According to the foregoing description, the present invention permits manufacture of a new class of transparent and fluorescent printing inks, which will produce very bright and vivid colors that will increase the aesthetic appeal of the graphical designs incorporating such colors. The use of nanodots that are available in various colors makes it possible to prepare the transparent and fluorescent printing inks of the present invention in more colors than are currently available in conventional transparent or fluorescent inks. Still further, these inks are transparent and therefore can be readily used in process printing or non-process printing, to thereby build (by overprinting) an unlimited number of secondary and tertiary colors.

Table 1 below shows the comparison of certain properties between transparent and fluorescent inks containing nanodots formed in accordance with one embodiment of the present invention (“Fluorescent,” in three colors: orange, pink, and green) and conventional transparent non-fluorescent inks (“Non-fluorescent,” also in three colors: orange, pink, and green).

TABLE 1

| | L* | a* | b* |
|---|---|---|---|
| Fluorescent | | | |
| Orange ink | 57.5 | 54.9 | 41.9 |
| Pink ink | 74.7 | 51.4 | −7.0 |
| Green ink | 81.5 | −34.2 | 40.2 |
| Non-fluorescent | | | |
| Orange ink | 57.4 | 54.4 | 41.6 |
| Pink ink | 73.3 | 50.2 | −9.4 |
| Green ink | 80.2 | −30.0 | 39.7 |

Table 1 lists color values in CIE L*a*b* format (D65/10° Observer) measured with a 10 nm bandwidth spectrophotometer equipped with a quartz-tungsten halogen light source. Lightness, L*, ranges from 0 to 100 and is an achromatic luminance measure of the relative “greyness” of an object. An L* of zero corresponds to black and 100 corresponds to white. All intermediate values imply shades of grey. The a* and b* parameters reflect “redness-greenness” and “yellowness-blueness,” respectively. These two parameters code the chromatic components of a three-dimensional color space. If the a* or b* values go to the positive, then object color is increasingly more red or yellow, respectively as the magnitude increases. Similarly, as a* and b* values go to the negative, then object color is increasingly more green or blue, respectively. When both parameters are near zero, then object color is achromatic or essentially grey, i.e., devoid of color and only influenced by its lightness, L*.

Table 1 demonstrates that in “Fluorescent” inks formed in accordance with the present invention, all values of L*, a*, and b* in three colors (except for value a* in color green) are greater than their counterparts in the conventional “Non-fluorescent” inks, indicating that the “Fluorescent” inks of the present invention are generally brighter and provide more saturated (or vivid or intense) colors. Value a* for the “Fluorescent” green ink is smaller than its counterpart in the conventional “Non-fluorescent” green ink, which also indicates that the “Fluorescent” green ink in accordance with the present invention is generally brighter and provides more saturated (or vivid or intense) color green, because a* reflects “redness-greenness” and, therefore, when a* goes to the negative, the color becomes increasingly more green.

While the preferred embodiments of the present invention have been illustrated and described, it will be appreciated that various changes can be made therein without departing from the sprit and scope of the invention.

The embodiments of the invention in which an exclusive property or privilege is claimed are defined as follows:

1. A method of creating a transparent and fluorescent colorant, comprising:
selecting one or more types of fluorescent nanodots for creating a colorant of a predefined color; and
combining the selected nanodots with a transparent base colorant to create a transparent and fluorescent colorant of the predefined color.

2. The method of claim 1, wherein the step of combining the selected nanodots with a transparent base colorant comprises doping the base colorant with the selected nanodots.

3. The method of claim 1, wherein the colorant is selected from the group consisting of an ink, paint, pigment, and dye.

4. The method of claim 1, wherein the colorant comprises a printing ink so that the method creates a transparent and fluorescent printing ink, the method further comprising:
confirming that the created transparent and fluorescent ink produces the predefined color when printed on a substrate.

5. A product made from the method of claim 1.

6. A method of creating a CMY set of transparent and fluorescent printing inks, comprising:
selecting one or more types of fluorescent nanodots for creating printing inks in cyan, magenta, and yellow, respectively; and
combining the selected nanodots with transparent base inks to create transparent and fluorescent inks in cyan, magenta, and yellow, respectively.

7. The method of claim 6, wherein the step of combining the selected nanodots with transparent base inks comprises doping the base inks with the selected nanodots to create transparent and fluorescent inks in cyan, magenta, and yellow, respectively.

8. The method of claim 6, further comprising:
confirming that the created transparent and fluorescent inks produce cyan, magenta, and yellow, respectively, when printed on a substrate.

9. A product made from the method of claim 6

10. A method of creating a spot-color set of transparent and fluorescent printing inks, comprising:
selecting one or more types of fluorescent nanodots for creating printing inks in a predefined set of spot colors; and
combining the selected nanodots with transparent base inks to create transparent and fluorescent inks in the predefined set of spot colors, respectively.

11. The method of claim 10, wherein the predefined set of spot colors includes two or more of red, green, blue, pink, and purple.

12. The method of claim 10, wherein the step of combining the selected nanodots with transparent base inks comprises doping the base inks with the selected nanodots to create transparent and fluorescent inks in the predefined set of spot colors, respectively.

13. The method of claim 10, further comprising:
confirming that the created spot-color transparent and fluorescent inks produce the predefined set of spot colors, respectively, when printed on a substrate.

14. A product made from the method of claim 10.
